(19) United States
(12) Patent Application Publication
(10) Pub. No.: US 2015/0196962 A1
(43) Pub. Date: Jul. 16, 2015

(54) FINISHING FACE MILL WITH REDUCED CHIP LOAD VARIATION AND METHOD OF OBTAINING THE SAME

(71) Applicant: ROTARY TECHNOLOGIES CORPORATION, EL SEGUNDO, CA (US)

(72) Inventors: WILLIAM J. ENDRES, HOUGHTON, MI (US); DOUGLAS J. WOODRUFF, ATLANTIC MINE, MI (US)

(21) Appl. No.: 14/597,125

(22) Filed: Jan. 14, 2015

Related U.S. Application Data
(60) Provisional application No. 61/927,408, filed on Jan. 14, 2014.

(51) Int. Cl. B23C 5/06; B23C 5/16

(52) U.S. Cl. CPC B23C 5/06; B23C 5/165; B23C 2210/28; B23C 2230/00; B23C 2250/00

(57) ABSTRACT

A face milling tool includes a body which is rotatable about an axis, at least one wiper tooth, and at least two primary cutting teeth mounted on the body having a cutting edge for cutting about the axis. The primary cutting teeth are staggered radially relative to each other by a radial shift so that a chip load variation during operation is less than 0.7 times a mean primary-tooth chip load. A method for determining the primary cutting tooth radial positions on a face milling tool body is provided such that a chip load variation during operation is less than 0.7 times a mean primary-tooth chip load.

### CROSS-REFERENCE TO RELATED APPLICATION

This application is based upon and claims priority to U.S. Provisional Application Ser. No. 61/927,408, filed on Jan. 14, 2014, the content of which is fully incorporated herein by reference.

### BACKGROUND OF THE INVENTION

A face milling tool, or face mill, has one or, more generally, multiple primary cutting teeth affixed to the face mill body around its circumference, generally substantially equally spaced, and aligned as best as possible to one another in both the axial and radial dimensions of the face mill. Each primary cutting tooth is generally made up of a replaceable cutting insert 6b (FIG. 2) and its provisions for attachment to the face mill body. Each insert 6b defines a cutting edge 6c that may be circular as shown in the illustrative examples here, or have a radiused tip where it forms the final surface. A face mill is operated by attaching it to the spindle of a machine tool. The spindle then rotates to produce a cutting motion at a relatively high cutting speed, the tangential speed, while the machine provides a feeding motion of the workpiece or the face mill, relative to the other, that occurs in the plane to which the spindle axis is generally perpendicular. The face mill removes a shallow layer of material from the workpiece creating, with the tips of the primary cutting teeth, a new surface on the workpiece that is substantially parallel to the plane of the feeding motion. Upon that surface and at a smaller, microscopic scale is the surface roughness. The surface roughness is comprised of a series of radiused feed grooves that trace the nearly-circular cutting motion of the primary cutting teeth. The feed grooves exhibit cusps/peaks occurring where adjacent feed grooves overlap one another leaving the radiused valleys of the feed grooves between the cusps/peaks.

The feeding action may be quantified as a distance traveled in the time it takes for one revolution of the face mill, referred to as the feed per revolution. Of greater significance as related to surface roughness is the feed per primary cutting tooth, which is the feed per revolution divided by the number of primary cutting teeth affixed to the face mill cutter body. The feed per primary tooth dictates the distance between the microscopic peaks—the widths of the feed grooves.

Surface roughness may be characterized by one or more of numerous quantitative parameters, such as the roughness average value that is generally referred to as Rₐ. Ideally, the roughness average value is proportional to the square of the feed per primary tooth and inversely proportional to the radius on the tips of the primary cutting teeth. In practice the roughness average value will exhibit these types of proportional and inversely proportional trends; however, because the multiple primary cutting teeth are not perfectly aligned with one another, the roughness average value in practice will always be higher (a rougher surface) than the ideal value. While the radial misalignments of the primary cutting teeth have a deleterious effect surface roughness by perturbing the widths of the feed grooves from their ideally equal widths, the axial misalignments of the primary cutting teeth have an even greater deleterious effect on surface roughness by also perturbing the depths of the feed grooves relative to their ideally equal depths.

Thus, four parameters combine to impact the surface roughness—feed per primary tooth, tooth tip radius (often referred to as the corner radius, or sometimes the nose radius), tooth-to-tooth axial misalignments, and tooth-to-tooth radial misalignments. Assuming one has reduced the misalignments to be as small as possible by applying the degree of effort that can be afforded, it is the feed per primary tooth and the corner radius that are adjusted to achieve the desired/specified surface roughness on a face milled surface. Decreasing the feed per primary tooth, due to its squared effect on Rₐ, has the greater impact on decreasing/improving (making more smooth) the surface roughness, but, holding all other cutting conditions constant, such as spindle speed, this also results in a proportionate decrease in productivity. Increasing the corner radius will result in a proportionate decrease/improvement in surface roughness, but it also tends to direct a larger percentage of the cutting forces acting between the primary cutting teeth and the workpiece into the axial direction, which can lead to structural deflections that result in dimensional error in the location of the face milled surface produced.

When producing a machined surface, it is common to take multiple passes, including one or more roughing passes to more rapidly remove larger amounts of material without concern for the aforementioned dimensional error or higher surface roughness, followed by a finish pass at a lower rate of material removal to facilitate meeting the dimensional and surface roughness requirements. To achieve particularly low surface roughness without excessively reducing the feed per primary tooth and, likewise, in the presence of some level of tooth-to-tooth misalignments that always exist in practice, one or more secondary “wiper” teeth may be added to the face mill. When viewed in the direction that is tangential to the face mill body (the cutting motion direction), wiper teeth have either a straight cutting edge 5b or a cutting edge with a very large radius or “crown” that is much larger than the corner radius of the primary cutting teeth (see FIG. 2). Wiper teeth serve to remove the cusps/peaks of the surface roughness geometry. Because Rₐ is inversely proportional to the radius of the cutting edge, and the radius of the wiper is either very large (or infinite in the case of a non-radiused/straight wiper tooth cutting edge), the wiper can create a much smaller Rₐ value even if the feed per wiper tooth is larger than the feed per primary tooth. Of course, if there is more than one wiper tooth, the multiple wiper teeth must be carefully aligned in the axial direction, and for that reason, there are generally far fewer wiper teeth than primary cutting teeth, which is consistent with the ability to accommodate higher feed per wiper tooth than feed per primary tooth.

Wiper teeth, or rather the indexible cutting insert 5c that makes up the cutting portion of the tooth, are usually common-size square or rectangular cutting inserts made from one of the many cutting insert materials (e.g., tungsten carbide, ceramic, cubic boron nitride, etc., either with or without a coating) that are well known to those working in the field. Viewing in the direction of the axis of the face mill, the wiper tooth cutting edge is substantially straight and has finite length 5d. Wiper teeth are set with their cutting edge length running substantially radially outward from the axis of the face mill. They are set at an axial position on the cutter body so the wiper cutting edge protrudes axially toward the machined surface just slightly more than the furthest protruding primary cutting tooth. The added protrusion of a wiper tooth may be up to approximately 0.003 inch (75 micron), sometimes less and sometimes more; it is desired to keep this added protrusion, or wiper depth, as small as possible while still assuring the wiper removes the entirety of all the cusps/peaks down to the lowest of the feed groove valleys. When a wiper has a non-radiused straight cutting edge, the wiper teeth may be set to have a very small angle relative to the feed plane so that the full, and generally excessive (relative to the feed per wiper tooth), length of the wiper tooth's cutting edge is not continuously rubbing on the machined surface that was wiped by a wiper tooth previously passing over that part of the surface. Generally a primary cutting tooth removes more than 0.003 inch of material in the axial direction whereas a wiper tooth removes 0.003 inch or less of material in the axial direction.

While a face mill having wiper teeth may have them in addition to a full complement of evenly spaced primary cutting teeth, most finishing face mills having wiper teeth replace a small number of the primary cutting teeth each with a wiper tooth, one wiper in each tooth location where a primary cutting tooth is replaced. While this is convenient and is easy to accomplish given the limited space available between successive primary cutting teeth, replacing some of the primary cutting teeth results in each primary cutting tooth that immediately follows a replaced primary cutting tooth location to experience twice the nominal feed per primary-tooth location. As such it removes double the nominal amount of material, which can cause all primary cutting teeth that immediately follow a wiper tooth to wear more quickly than the other primary cutting teeth. The feed experienced by a primary cutting tooth, meaning the feed distance traveled since the previous primary cutting tooth passed over the same cutter-angular location on the workpiece, is often referred to as “chip load”. When a wiper tooth replaces a primary cutting tooth, the distance travelled by the primary cutting tooth (that is immediately following the wiper tooth) since the previous primary cutting tooth (that is immediately preceding the wiper tooth) passed that same cutter-angular location on the workpiece, is twice as far since the angular spacing to the previous primary tooth is the angular spacing to the wiper tooth location plus the angular spacing from the wiper tooth location to the preceding primary tooth location, or two times the nominal distance travelled per tooth location.

Generally, a wiper tooth has a means of axial adjustment so that the wiper tooth can be adjusted to the desired wiper depth (relative to the furthest axially protruding primary cutting tooth) and, in the case of multiple wiper teeth, adjusted to be well aligned with all other wiper teeth. It is common, though without restriction, for there to be one wiper tooth for every three to ten primary cutting teeth.

### SUMMARY OF THE INVENTION

In an example embodiment a face milling tool is provided including a body which is rotatable about an axis, at least one wiper tooth, and at least two primary cutting teeth mounted on the body having a cutting edge for cutting about the axis. The primary cutting teeth are staggered radially relative to each other by a radial shift so that a chip load variation during operation is less than 0.7 times a mean primary-tooth chip load. In one example embodiment, the radial shift Δrᵢ₊₁ of each primary cutting tooth i+1 is a function of a radial shift Δrᵢ from an angular location i and of an angle Δθ_{i,i+1} relative to said angular location i, where

$$Δ {r}_{i + 1} = ( \frac{1}{{z}_{p}} - \frac{Δ {θ}_{i , i + 1}}{2 π} ) {f}_{n} + Δ {r}_{i} , Δ {r}_{0} = 0 , r = 0 , 2 , … , {z}_{p} - 1 ,$$

where,
zₚ is the number of primary cutting teeth on the face milling tool,
fₙ is the feed per revolution.

In another example embodiment, the preceding angular location is a location of one of said at least two primary cutting teeth, where,

$$Δ {r}_{i + 1} = ( \frac{1}{{z}_{p}} - \frac{Δ {θ}_{i , i + 1}}{2 π} ) {f}_{n} + Δ {r}_{i} , Δ {r}_{1} = 0 , r = 1 , 2 , … , {z}_{p} - 1 ,$$

where,
zₚ is the number of primary cutting teeth on the face milling tool,
fₙ is the feed per revolutio.

In a further example embodiment, the chip load variation during operation is less than 0.6 times the mean primary-tooth chip load. In yet a further example embodiment, the chip load variation during operation is less than 0.5 times the mean primary-tooth chip load. In another example embodiment, the chip load variation during operation is less than 0.4 times the mean primary-tooth chip load. In yet another example embodiment, the chip load variation during operation is less than 0.3 times the mean primary-tooth chip load. In one example embodiment, the chip load variation during operation is less than 0.2 times the mean primary-tooth chip load. In yet another example embodiment, the chip load variation during operation is less than 0.1 times the mean primary-tooth chip load. In a further example embodiment, each of the at least one wiper tooth is set for removing 0.003 inch or less of material in the tool axial direction. In yet a further example embodiment, each primary cutting tooth is set for removing more than 0.003 inch of material in the tool axial direction.

In another example embodiment, a method for determining the primary cutting tooth radial positions on a face milling tool body is provided. The milling tool includes a body which is rotatable about an axis, at least one wiper tooth, and at least two primary cutting teeth mounted on the body having a cutting edge for cutting about the axis. The primary cutting teeth are staggered radially relative to each other so that a chip load variation during operation is less than 0.7 times a mean primary-tooth chip load. The method includes defining a number of primary cutting teeth zₚ on the face mill, defining the feed per revolution fₙ at which chip load variation should be minimized, defining a base angular location (i=0) for which Δr₀=0, identifying the angle, Δθ_{0,1}, from the base angular location (i=0) to a primary cutting tooth (i=1) following the base angular location, and setting a radial shift for each primary cutting tooth, where

$$Δ {r}_{i + 1} = ( \frac{1}{{z}_{p}} - \frac{Δ {θ}_{i , i + 1}}{2 π} ) {f}_{n} + Δ {r}_{i} , Δ {r}_{0} = 0 , i = 0 , 2 , … , {z}_{p} - 1$$

In a further example embodiment, the base angular location is a location of a primary cutting tooth location (i=1) and the radial shift for each other primary cutting tooth is set as

$$Δ {r}_{i + 1} = ( \frac{1}{{z}_{p}} - \frac{Δ {θ}_{i , i + 1}}{2 π} ) {f}_{n} + Δ {r}_{i} , Δ {r}_{1} = 0 , i = 1 , 2 , … , {z}_{p} - 1$$

In a further example embodiment method, the chip load variation during operation is less than 0.6 times the mean primary-tooth chip load. In yet a further example embodiment, the chip load variation during operation is less than 0.5 times the mean primary-tooth chip load. In another example embodiment, the chip load variation during operation is less than 0.4 times the mean primary-tooth chip load. In yet another example embodiment, the chip load variation during operation is less than 0.3 times the mean primary-tooth chip load. In one example embodiment, the chip load variation during operation is less than 0.2 times the mean primary-tooth chip load. In yet another example embodiment, the chip load variation during operation is less than 0.1 times the mean primary-tooth chip load. In a further example embodiment, each of the at least one wiper tooth is set for removing 0.003 inch or less of material in the tool axial direction. In yet a further example embodiment, each primary cutting tooth is set for removing more than 0.003 inch of material in the tool axial direction.

### BRIEF DESCRIPTION OF THE DRAWINGS

FIG. 1 is a wiper-based finishing face mill showing eight primary cutting teeth and two wiper teeth that have replaced two of the primary teeth in two tooth locations.

FIG. 2 is a wiper-based finishing face mill shown in FIG. 1 indicating the sequencing of primary teeth as related to their radial shifting.

FIG. 3 is a wiper-based finishing face mill with primary cutting teeth unevenly distributed between multiple wiper teeth.

FIG. 4 is a wiper-based finishing face mill showing the relative primary-tooth angles used to determine radial shift values.

FIG. 5 is a wiper-based finishing face mill showing the sequence of teeth relative to defining one of the primary cutting teeth as the base angular location (location 0).

FIG. 6 is a wiper-based finishing face mill showing the sequence of teeth relative to arbitrarily defining the base angular location (location 0).

FIG. 7 depicts an example method of designing a wiper-based finishing face mill.

### DETAILED DESCRIPTION

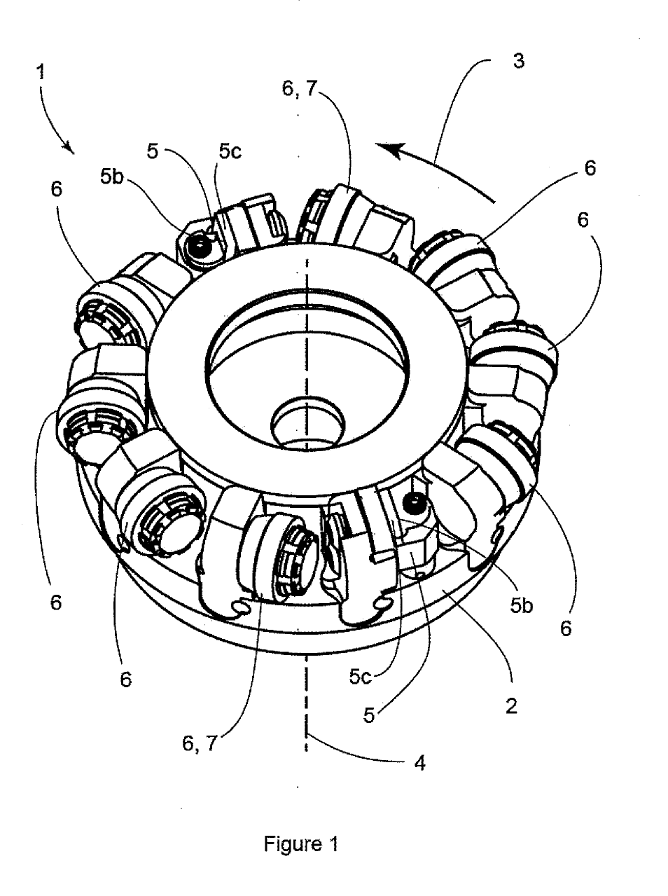

A finishing face mill 1 disclosed herein improves/decreases surface roughness. The present disclosure applies to any wiper-based finishing face mill, having a body 2 that is provided a rotating motion 3 about an axis 4 to provide a cutting motion, that incorporates, as shown in FIG. 1, its wiper teeth 5 (having cutting edge 5b) in place of primary cutting teeth 6 which results in a wiper-following primary cutting tooth 7, which is a primary cutting tooth that follows each replaced primary cutting tooth location where a wiper tooth has been placed, experiencing double the nominal chip load, f_{z}, where f_{z}=fₙ/zₙ, where fₙ is the feed per revolution and zₙ is the number of tooth locations on the cutter. It is described here with the assumption that tooth locations are evenly spaced circumferentially/angularly. Some face milling cutters have some departure from even spacing as a means of interrupting vibration regeneration that leads to instability and chatter, hence increasing the stability of the cutter. This method applies to finishing face mills of that type as well, though it is described for simplicity sake for the even spacing case.

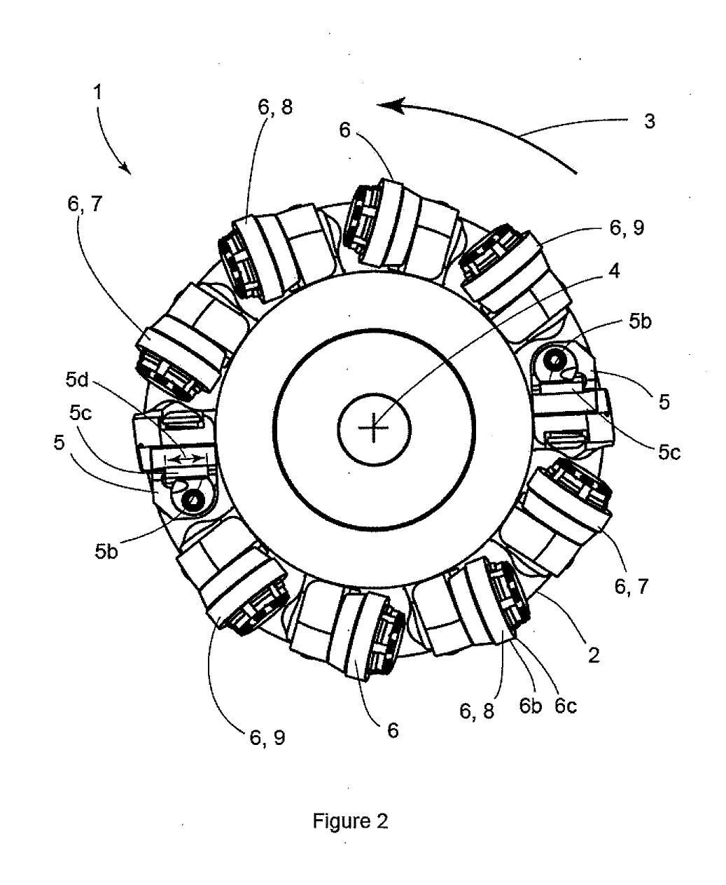

The wiper-based finishing face mill of the present disclosure staggers, or shifts, the primary cutting teeth 6 in the radial direction such that the chip load experienced by a primary cutting tooth, f_{zi}, is at least similar to the chip load experienced by all other primary teeth, f_{zj}. Referring to FIG. 2, because the primary cutting tooth 6 immediately following a wiper tooth 5 (a wiper-following primary cutting tooth 7) would naturally experience two times the nominal chip load (2f_{z}), moving inward radially by a distance equal to the nominal chip load would result in it experiencing only one times the nominal chip load (1f_{z}). However, in this case the subsequent primary cutting tooth 8, the second following the wiper tooth 5, would then experience double the nominal chip load (2f_{z}). However, if a wiper-following primary cutting tooth 7 (one tooth location behind a wiper tooth) is moved inward radially by a distance of less than the nominal chip load (f_{z}−δ), and then the respective subsequent primary cutting tooth 8 is moved inward radially by slightly less (f_{z}−2δ) than the primary cutting tooth preceding it (the respective wiper-following primary cutting tooth 7), then both those primary cutting teeth will experience a chip load of f_{z}+δ. Moving inward, by (f_{z}−i·δ), each primary cutting tooth which is i tooth locations behind its preceding wiper tooth 5, for i=1 to z_{p,Δw}, z_{p,Δw} being the number of primary cutting teeth between successive wiper teeth, will result in all primary cutting teeth experiencing a chip load of f_{z}+δ. Naturally, δ=f_{z}/z_{p,Δw} and the z_{p,Δw}^{th} primary cutting tooth 9 is moved inward radially by a distance f_{z}−i·δ=f_{z}−z_{p,Δw}·f_{z}/z_{p,Δw}=f_{z}−f_{z}=0.

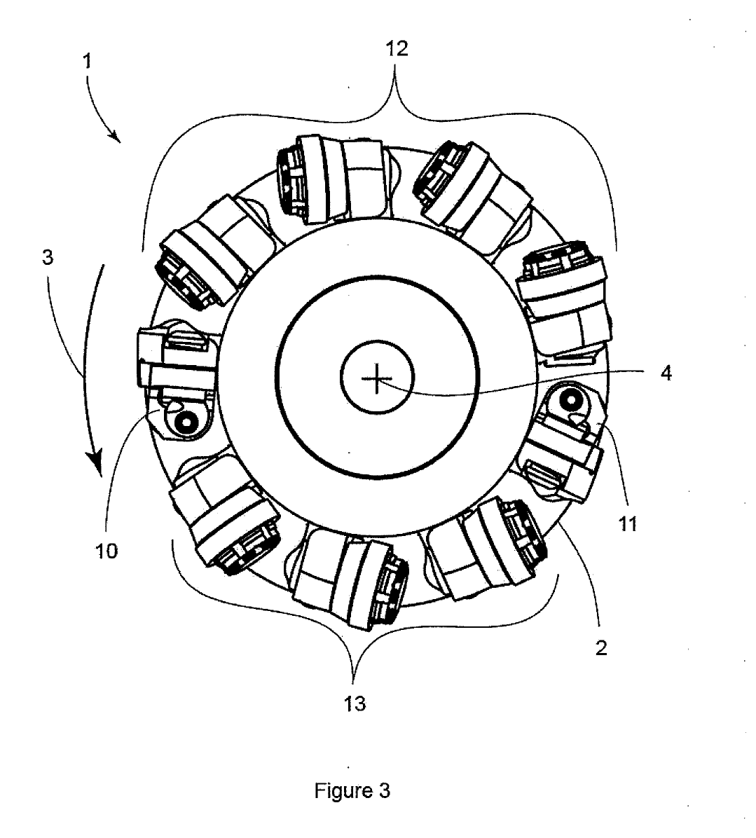

In some cases, such as that shown in FIG. 3, where there are multiple wiper teeth, it may not be possible to have the same number of primary cutting teeth 6 between successive wiper teeth 5; for instance, if a face mill has nine (9) tooth locations and it is desired to have wiper teeth in two (2) of those tooth locations, there are a total of 9−2=7 primary cutting teeth. Having the same number of primary cutting teeth between the first wiper tooth 10 the second wiper tooth 11 and between the second wiper tooth 11 and (wrapping further around to) the first wiper tooth 10 would require 7/2=3.5 primary cutting teeth between each wiper teeth. Of course, it is impossible to have a fraction of a tooth; so, as shown in FIG. 3, between the first wiper tooth 10 and the second wiper tooth 11 there may be four (4) primary cutting teeth 12 and between the second wiper 11 tooth and (wrapping further around to) the first wiper tooth 10 there would be 7−4=3 primary cutting teeth 13. So, the previous explanation may be extended to the more general case, where the specific locations of the wiper teeth 5 are irrelevant and the number of primary cutting teeth 6 between wiper teeth is irrelevant, as follows.

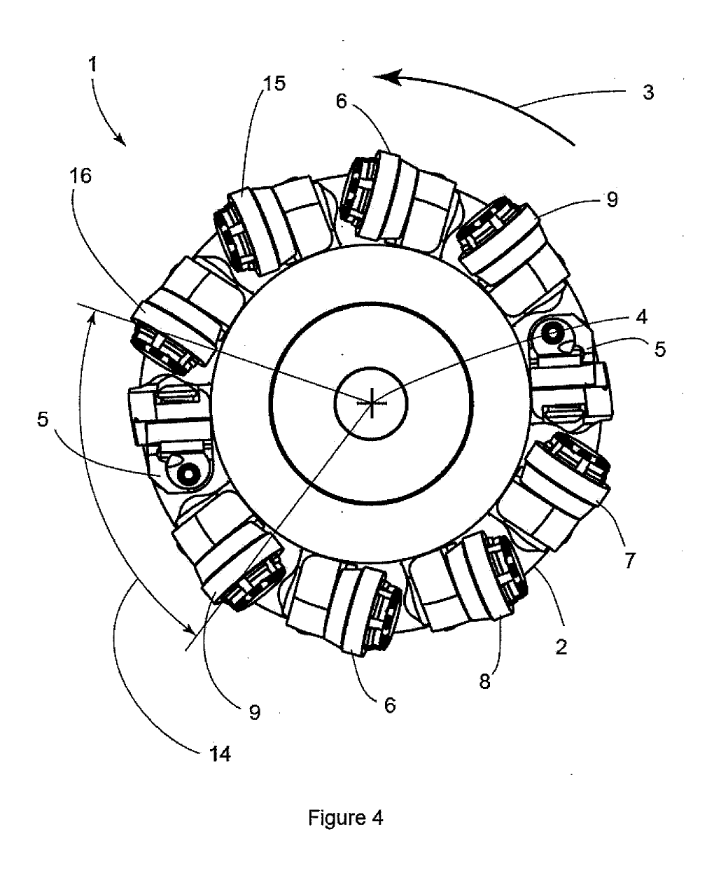

Referring to FIG. 4, if the angular spacing between successive primary cutting teeth 14 is Δθ_{i,i+1} where primary cutting tooth “i+1” 15 follows primary cutting tooth “i” 16, Δθ_{i,i+1} of course being known for all primary cutting teeth 6, and there are zₚ primary cutting teeth 6, the distance by which each primary cutting tooth i+1 should be moved outward radially so that all primary cutting teeth experience the same chip load of fₙ/zₚ is

$$Δ {r}_{i + 1} = {ɛ}_{i , i + 1} + Δ {r}_{i} = ( \frac{1}{{z}_{p}} - \frac{Δ {θ}_{i , i + 1}}{2 π} ) {f}_{n} + Δ {r}_{i} ,$$

Δθ_{i,i+1} in radians,
where, depending on which tooth, or more generally which tooth's angular location, corresponds to Δr=0, computed Δr values may be either positive or negative (or zero), negative values indicating an inward radial shift. As such, the distance from the cutter axis 4 to a primary cutting tooth i is Rₜ+Δrᵢ where Rₜ is the nominal or mean cutting radius of the tool. When Δrᵢ is positive, tooth i cuts at a slightly larger radius than the nominal tool radius Rₜ and when Δrᵢ is negative, tooth i cuts at a slightly smaller radius than the nominal tool Rₜ.

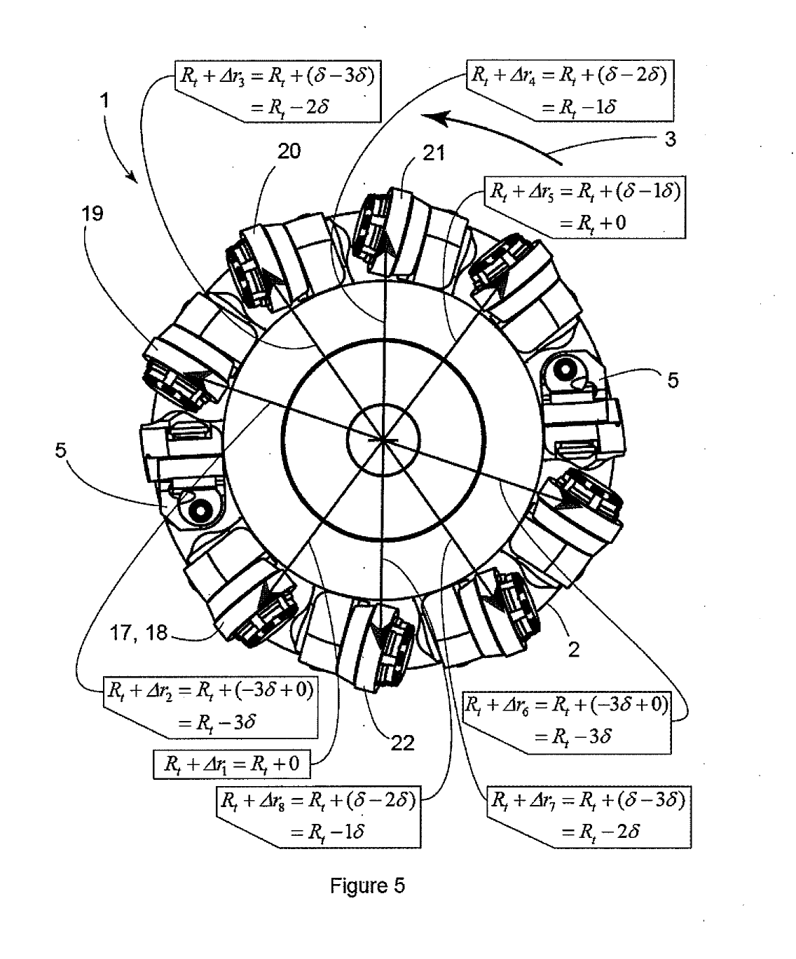

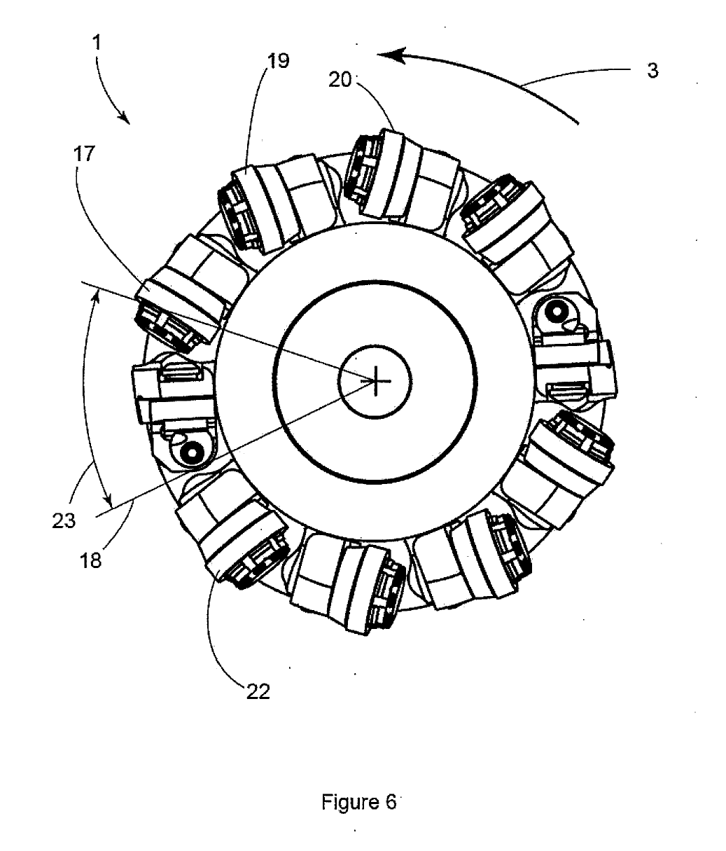

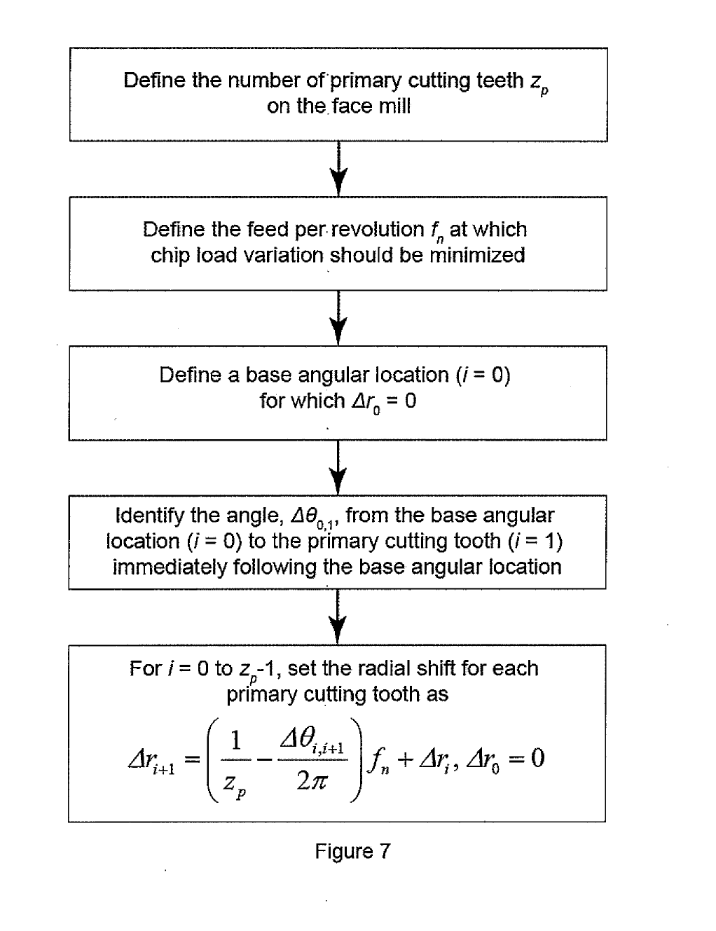

Referring to FIG. 5 (considering for the sake of illustration only two wiper teeth equally separating two sets of four evenly spaced primary cutting teeth and letting δ=0.025fₙ for illustrating in the figure), to determine the values for all Δrᵢ₊₁, begin by choosing a first primary cutting tooth (i−1) 17 as the base angular location 18 and set Δr₁=0. Next, calculate Δr₂ for primary cutting tooth 19 (i=2) in terms of Δr₁ where ε_{1,2}=(⅛− 2/10)fₙ=−0.075fₙ and Δr₂=−0.075fₙ+0. Then Δr₃ for primary cutting tooth 20 (i=3) is determined in terms of Δr₂ where ε_{2,3}=(⅛− 1/10)fₙ=+0.025fₙ and Δr₃=+0.025fₙ+(−0.075fₙ)=−0.050fₙ. Next Δr₄ for primary cutting tooth 21 (i=4) is determined in terms of Δr₃ where ε_{3,4}=(⅛− 1/10)fₙ=+0.025fₙ and Δr₄=+0.025fₙ+(−0.050fₙ)=−0.025fₙ. This continues to the final primary cutting tooth 22, number (i=zₚ). In the most general sense, referring to FIG. 6 and FIG. 7, the method of designing a face mill according to the present disclosure begins by selecting any angular location to be the base angular location 18 (i.e., where Δr₀=0) where the equation above is used first with Δθ_{0,1} as the angular position 23 of the first primary cutting tooth 17, that is, a primary cutting tooth (i=1) following the base location (i=0), measured relative to that base angular location (location 0). In other words, the base angular location need not correspond to an actual tooth location; what is important is not the absolute level of each radial shift, rather all radial shift levels relative to each other.

Of course, in practice, achieving these exact values of Δr for each primary cutting tooth may be impractical. However, calculating the ideal values from the above equation and then rounding to practically achievable increments will greatly reduce the variation in chip load seen by all the primary cutting teeth, generally such that the chip load variation f_{zi,max}−f_{zi,min}, relative to the mean primary-tooth chip load fₙ/zₚ, measured across all primary cutting teeth, is at 50% or below; that is

$$\frac{{f}_{zi , ma x} - {f}_{zi , m i n}}{{f}_{n} / {z}_{p}} \leq 0.5 ,$$

where,
f_{zi,max} is the maximum chip load, that is, the chip load on the primary cutting tooth that experiences the greatest chip load of all primary cutting teeth, and
f_{zi,min} is the minimum chip load, that is, the chip load on the primary cutting tooth that experiences the smallest chip load of all primary cutting teeth.

Without implementing this technique, f_{zi,max}=2f_{z}=2fₙ/zₙ and f_{zi,min}=f_{z}=fₙ/zₙ, where, recalling from earlier, zₙ is the total number of tooth locations, which is the sum of the number of primary cutting teeth, zₚ, and the number of wiper teeth. The following table shows some examples of the primary-tooth chip load variation, as defined here, that occur without implementing this technique for a representative selection of typical primary and wiper tooth counts for finishing face mills.

| Tooth | Primary | Wiper | Chip-Load |
|---|---|---|---|
| Locations | Teeth | Teeth | Variation |
| 6 | 5 | 1 | 0.83 |
| 8 | 7 | 1 | 0.88 |
| 10 | 8 | 2 | 0.80 |
| 14 | 12 | 2 | 0.86 |
| 17 | 14 | 3 | 0.82 |
| 21 | 18 | 3 | 0.86 |
| 24 | 20 | 4 | 0.83 |
| 28 | 24 | 4 | 0.86 |

As can be seen, these representative cases have primary-tooth chip load variation greater than or equal to 0.8. Applying this technique, even without being able to achieve the ideal levels of (resolution in) Δr values, to achieve primary-tooth chip load variation of 0.5 (or less) results in at least a 100×(0.5−0.8)/0.8=37.5% reduction in primary-tooth chip load variation compared to what is achievable without this technique, in the best case of those illustrated.

In example embodiments, the chip load variation is 40% or less. In another example embodiment the chip load variation was 30% or less. In yet another example embodiment, the chip load variation was 20% or less. In a further example embodiment, the chip load variation was 10% or less. In a further example embodiment, the chip load variation was 70% or less and in another example embodiment was 60%.

In the case of having only one primary cutting tooth between successive wiper teeth, there is no opportunity to apply this technique. However, if there are two or more primary cutting teeth between successive wiper teeth, this technique will reduce chip load variation, in particular by eliminating the theoretically double chip load experienced by each primary cutting tooth that follows a wiper tooth. It should be noted that the number of wiper teeth is generally desired to be a small percentage of the total number of tooth locations so as to ease the task of axially aligning the multiple wiper teeth with one another, so the case of only one primary cutting tooth between successive wiper teeth is not likely to be seen in practice.

What is claimed is:

1. A face milling tool comprising:
a body, said body being rotatable about an axis;
at least one wiper tooth; and
at least two primary cutting teeth mounted on the body having a cutting edge for cutting about said axis, said primary cutting teeth are staggered radially relative to each other by a radial shift so that a chip load variation during operation is less than 0.7 times a mean primary-tooth chip load.

2. The face milling tool of claim 1, wherein the radial shift Δrᵢ₊₁ of each primary cutting tooth i+1 is a function of a radial shift Δrᵢ from an angular location i and of an angle Δθ_{i,i+1} relative to said angular location i, where,
$$Δ {r}_{i + 1} = ( \frac{1}{{z}_{p}} - \frac{Δ {θ}_{i , i + 1}}{2 π} ) {f}_{n} + Δ {r}_{i} , Δ {r}_{0} = 0 , i = 0 , 2 , … , {z}_{p} - 1 ,$$
where,
Δθ_{i,i+1} is measured in radians,
zₚ is the number of primary cutting teeth on the face milling tool,
fₙ is the feed per revolution.

3. The face milling tool of claim 2, wherein said preceding angular location is a location of one of said at least two primary cutting teeth, where,
$$Δ {r}_{i + 1} = ( \frac{1}{{z}_{p}} - \frac{Δ {θ}_{i , i + 1}}{2 π} ) {f}_{n} + Δ {r}_{i} , Δ {r}_{1} = 0 , i = 1 , 2 , … , {z}_{p} - 1 ,$$
where,
Δθ_{i,i+1} is measured in radians,
zₚ is the number of primary cutting teeth on the face milling tool,
fₙ is the feed per revolution.

4. The face milling tool according to claim 1, wherein the chip load variation during operation is less than 0.6 times the mean primary-tooth chip load.

5. The face milling tool according to claim 1, wherein the chip load variation during operation is less than 0.5 times the mean primary-tooth chip load.

6. The face milling tool according to claim 1, wherein the chip load variation during operation is less than 0.4 times the mean primary-tooth chip load.

7. The face milling tool according to claim 1, wherein the chip load variation during operation is less than 0.3 times the mean primary-tooth chip load.

8. The face milling tool according to claim 1, wherein the chip load variation during operation is less than 0.2 times the mean primary-tooth chip load.

9. The face milling tool according to claim 1, wherein the chip load variation during operation is less than 0.1 times the mean primary-tooth chip load.

10. The face milling tool according to claim 1, wherein each of said at least one wiper tooth is set for removing 0.003 inch or less of material in the tool axial direction.

11. The face milling tool according to claim 10, wherein each cutting tooth is set for removing more than 0.003 inch of material in the tool axial direction.

12. A method for determining the primary cutting tooth radial positions on a face milling tool body comprising:
a body, said body being rotatable about an axis;
at least one wiper tooth; and
at least two primary cutting teeth mounted on the body having a cutting edge for cutting about said axis, said primary cutting teeth being shifted radially relative to each other so that a chip load variation during operation is less than 0.7 times a mean primary-tooth chip load;
the method comprising:
defining a number of primary cutting teeth zₚ on the face mill;
defining the feed per revolution fₙ at which chip load variation should be minimized;
defining a base angular location (i=0) for which Δr₀=0;
identifying the angle, Δθ_{0,1}, from the base angular location (i=0) to a primary cutting tooth (i=1) following the base angular location; and
setting a radial shift for each primary cutting tooth as
$$Δ {r}_{i + 1} = ( \frac{1}{{z}_{p}} - \frac{Δ {θ}_{i , i + 1}}{2 π} ) {f}_{n} + Δ {r}_{i} , Δ {r}_{0} = 0 , i = 0 , 2 , … , {z}_{p} - 1$$
where,
Δθ_{i,i+1} is measured in radians,
zₚ is the number of primary cutting teeth on the face milling tool,
fₙ is the feed per revolution.

13. The method of claim 12, wherein the base angular location is a location of a primary cutting tooth location (i=1) and the radial shift for each other primary cutting tooth is set as
$$Δ {r}_{i + 1} = ( \frac{1}{{z}_{p}} - \frac{Δ {θ}_{i , i + 1}}{2 π} ) {f}_{n} + Δ {r}_{i} , Δ {r}_{1} = 0 , i = 1 , 2 , … , {z}_{p} - 1$$
where,
Δθ_{i,i+1} is measured in radians,
zₚ is the number of primary cutting teeth on the face milling tool,
fₙ is the feed per revolution.

14. The method as recited in claim 13, wherein the chip load variation during operation is less than 0.6 times the mean primary-tooth chip load.

15. The method as recited in claim 13, wherein the chip load variation during operation is less than 0.5 times the mean primary-tooth chip load.

16. The method as recited in claim 13, wherein the chip load variation during operation is less than 0.4 times the mean primary-tooth chip load.

17. The method as recited in claim 13, wherein the chip load variation during operation is less than 0.3 times the mean primary-tooth chip load.

18. The method as recited in claim 13, wherein the chip load variation during operation is less than 0.2 times the mean primary-tooth chip load.

19. The method as recited in claim 13, wherein the chip load variation during operation is less than 0.1 times the mean primary-tooth chip load.

20. The method as recited in claim 13, wherein each of said at least one wiper tooth is set for removing 0.003 inch or less of material in the tool axial direction.

21. The method as recited in claim 20, wherein each cutting tooth is set for removing more than 0.003 inch of material in the tool axial direction.
